(19) United States
(12) Patent Application Publication
(10) Pub. No.: US 2011/0234776 A1
(43) Pub. Date: Sep. 29, 2011

(54) ORGANIC EL DISPLAY DEVICE AND ORGANIC EL DISPLAY METHOD

(76) Inventor: Jun HANARI, Kanazawa-shi (JP)

(21) Appl. No.: 13/043,949

(22) Filed: Mar. 9, 2011

(30) Foreign Application Priority Data
Mar. 24, 2010 (JP) 2010-068937

(51) Int. Cl. H04N 13/04; G09G 5/10; G09G 3/32

(52) U.S. Cl. 348/56; 345/691; 345/77; 348/E13.075

(57) ABSTRACT

According to one embodiment, a device includes a plurality of pixels configured to include an organic EL element and a pixel circuit which controls the organic EL element, a plurality of video signal lines configured to be connected to the pixel circuit for every column and provide a video signal, and a plurality of scanning signal lines configured to be connected to the pixel circuit for every row for causing a write operation of writing the video signal to the pixel circuit and a light emitting operation of the organic EL element, and provide a scanning signal for controlling in a manner that a time from end of the write operation to start of the light emitting operation sequentially becomes shorter from a first row to a last row of the pixel circuit while keeping a light emission duration in each organic EL element constant.

### CROSS-REFERENCE TO RELATED APPLICATIONS

This application is based upon and claims the benefit of priority from Japanese Patent Application No. 2010-068937, filed Mar. 24, 2010; the entire contents of which are incorporated herein by reference.

### FIELD

Embodiments described herein relate generally to an organic electro luminescence (EL) display device and an organic EL display method.

### BACKGROUND

A flat panel display using an organic electro luminescence (EL) element, a liquid crystal display element, and the like normally displays two-dimensional information, but is not limited thereto, and a technique enabling a stereoscopic display is proposed.

For instance, an electronic device comprising a display unit for selectively switching and displaying a 2D (two-dimensional) and a 3D (three-dimensional) image, the electronic device having a display function of forcibly switching to the 2D image display at the time of 3D image display is known.

In such technique, a parallax barrier method is used. A pixel for the right eye and a pixel for the left eye are individually formed on the display panel. A parallax barrier layer and the like is formed so that one of the lights transmitted through and emitted from the respective pixel can be observed from the diagonal direction. However, in such parallax barrier method, the spatial resolution of the display image lowers to ½ of the number of pixels of the display panel since the pixel for the right eye and the pixel for the left eye need to be differed.

In another technique, the stereoscopic display corresponding to the left and right parallax is realized by switching and displaying the image for the right eye and the image for the left eye for every frame, and looking at the same using an eyeglass with an optical shutter. According to such method, the stereoscopic image can be displayed without lowering the spatial resolution.

In the display method in the organic EL display device, the display is started from the first line at the very top of the screen, and then the lower lines are sequentially displayed. In this method, the display of one image is terminated when displayed up to the last line at the very bottom of the screen, and then the next image is displayed from the first line at the very top of the screen.

In the case of the normal display, that is, the two-dimensional display, the display contents of the previous and next images are the same or have continuity, and thus problems do not arise in terms of visual recognition even if the previous and next images coexist one above the other and displayed in one screen.

In the case of the three-dimensional display, however, the previous and next images are the image for the left eye and the image for the right eye and thus are not the same and do not have continuity. Therefore, the quality of the three-dimensional display lowers when the left and right images coexist (cross talk).

### BRIEF DESCRIPTION OF THE DRAWINGS

FIG. 1 is an exemplary plan view schematically showing the configuration of an organic EL display device adopting an active matrix drive method of the present embodiment;

FIG. 2 is an exemplary view showing the configuration and the connection of the pixel PX and the video signal line driver XDR of the present embodiment;

FIG. 3 is an exemplary timing chart showing the scanning signals provided from the scanning signal lines to the pixel according to the present embodiment;

FIG. 4 is an exemplary view describing the three-dimensional display method in the organic EL display device of the present embodiment;

FIG. 5 is an exemplary timing chart showing the light emitting operation for every line of the present embodiment;

FIG. 6 is an exemplary view showing the configuration and the connection of the pixel and the video signal line driver of the current program method according to the present embodiment;

FIG. 7 is an exemplary timing chart showing the detailed signal for realizing the light emission timing of the present embodiment;

FIG. 8 is an exemplary view showing one example of a circuit configuration for generating a scanning signal of the present embodiment;

FIG. 9 is an exemplary timing chart showing the detailed signal for realizing the scanning signal of the present embodiment;

FIG. 10 is an exemplary view showing one example of a circuit configuration for generating a scanning signal of the present embodiment;

FIG. 11 is an exemplary timing chart showing the detailed signal for realizing the scanning signal of the present embodiment;

FIG. 12 is an exemplary view showing one example of a circuit configuration for generating a scanning signal of the present embodiment; and

FIG. 13 is an exemplary timing chart showing the detailed signal for realizing the scanning signal of the present embodiment.

### DETAILED DESCRIPTION

In general, according to one embodiment, an organic EL display device comprising: a plurality of pixels configured to be arranged in a matrix form and include an organic EL element and a pixel circuit which controls light emission/non-light emission of the organic EL element; a plurality of video signal lines configured to be connected to the pixel circuit for every column and provides a video signal; and a plurality of scanning signal lines configured to be connected to the pixel circuit for every row and provide a write control signal for controlling a video write operation of the pixel circuit, and configured to be connected to the organic EL element for every row and provide a light emission control signal for controlling a light emitting operation of the organic EL element, the write control signal and the light emission control signal being generated based on a clock pulse train, which is a reference signal, and a waiting time from a video write end timing to the pixel circuit to a light emission start timing of the organic EL element in an arbitrary row being different from the waiting time in an adjacent row by a time corresponding to ½ clock pulse.

One aspect of the present invention will be described in detail below with reference to the drawings. The same reference numerals are denoted for the constituent elements exhibiting the same or similar functions in each figure, and the redundant description will be omitted.

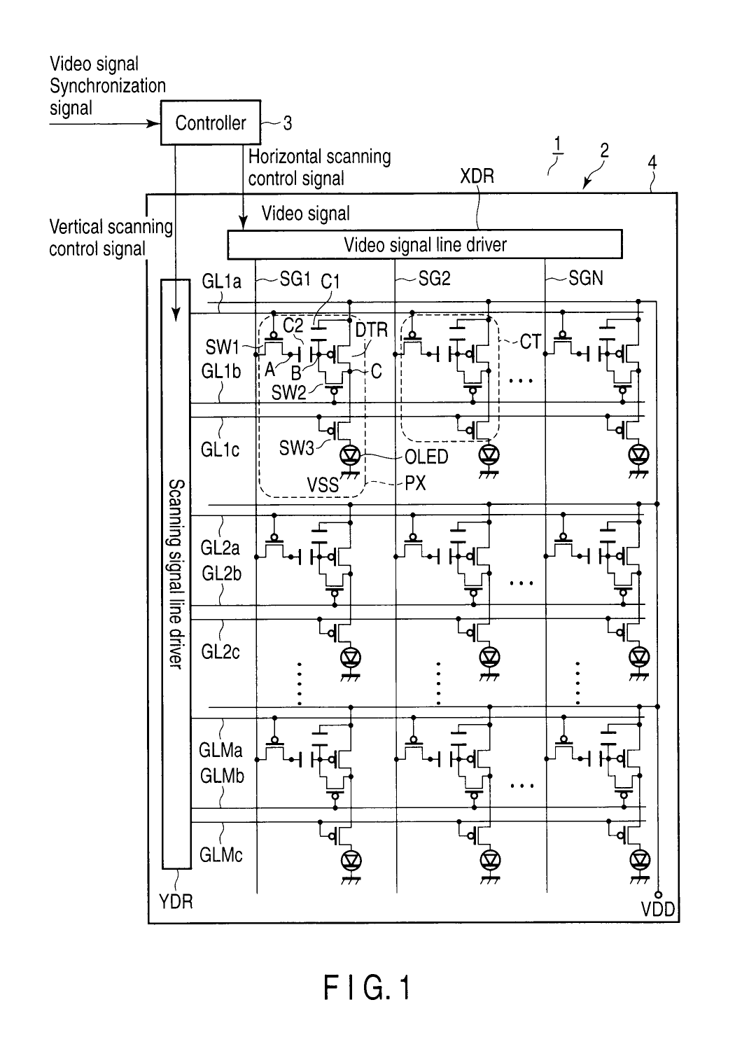

FIG. 1 is an exemplary plan view schematically showing the configuration of an organic EL display device adopting an active matrix drive method of the present embodiment.

The organic EL display device 1 comprises an organic EL panel 2, and a controller 3 that controls the display operation of the organic EL panel 2.

The organic EL panel 2 comprises a plurality of pixels PX, a plurality of scanning signal lines GL1a to GLMa, GL1b to GLMb, GL1c to GLMc, a plurality of video signal lines SG1 to SGN, a scanning signal line driver YDR and a video signal line driver XDR.

The plurality of pixels PX are arrayed in an M×N matrix on a supporting substrate 4 having light transmissive property and insulating property such as a glass plate. Each pixel PX comprises an organic EL element OLED which is a self luminous element, and also comprises a pixel circuit CT. The details of the pixel circuit CT will be described later.

The scanning signal lines GL1a to GLMa, GL1b to GLMb, GL1c to GLMc are extended along the row of pixels PX. The video signal lines SG1 to SGN are extended in a direction substantially orthogonal to the row of pixels PX. The scanning signal line driver YDR sequentially drives the scanning signal lines GL1a to GLMa, GL1b to GLMb, GL1c to GLMc. The video signal line driver XDR drives the video signal lines SG1 to SGN.

The controller 3 is formed on a printed board arranged exterior to the organic EL panel 2, and controls the operation of the scanning signal line driver YDR and the video signal line driver XDR. The controller 3 receives a digital video signal and a synchronization signal provided from the outside, generates a vertical scanning control signal that controls the vertical scanning timing and a horizontal scanning control signal that controls the horizontal scanning timing based on the synchronization signal, provides the vertical scanning control signal and the horizontal scanning control signal to the scanning signal line driver YDR and the video signal line driver XDR, respectively, and provides the digital video signal to the video signal line driver XDR in synchronization with the horizontal and vertical scanning timing.

The video signal line driver XDR converts the digital video signal to an analog format under the control of the horizontal scanning control signal in each horizontal scanning period, and provides the resultant video signal Vsig to the plurality of video signal lines SG1 to SGN in parallel. The video signal line driver XDR outputs a reset signal Vrst (to be described later) to the video signal lines SG1 to SGN.

The scanning signal line driver YDR outputs the scanning signal to the scanning signal lines GL1a to GLMa, GL1b to GLMb, GL1c to GLMc under the control of the vertical scanning control signal. The period from the start of output of the scanning signal with respect to the pixel PX of one line until the start of output of the scanning signal with respect to the pixel PX of the next line is defined as one horizontal scanning period (1H).

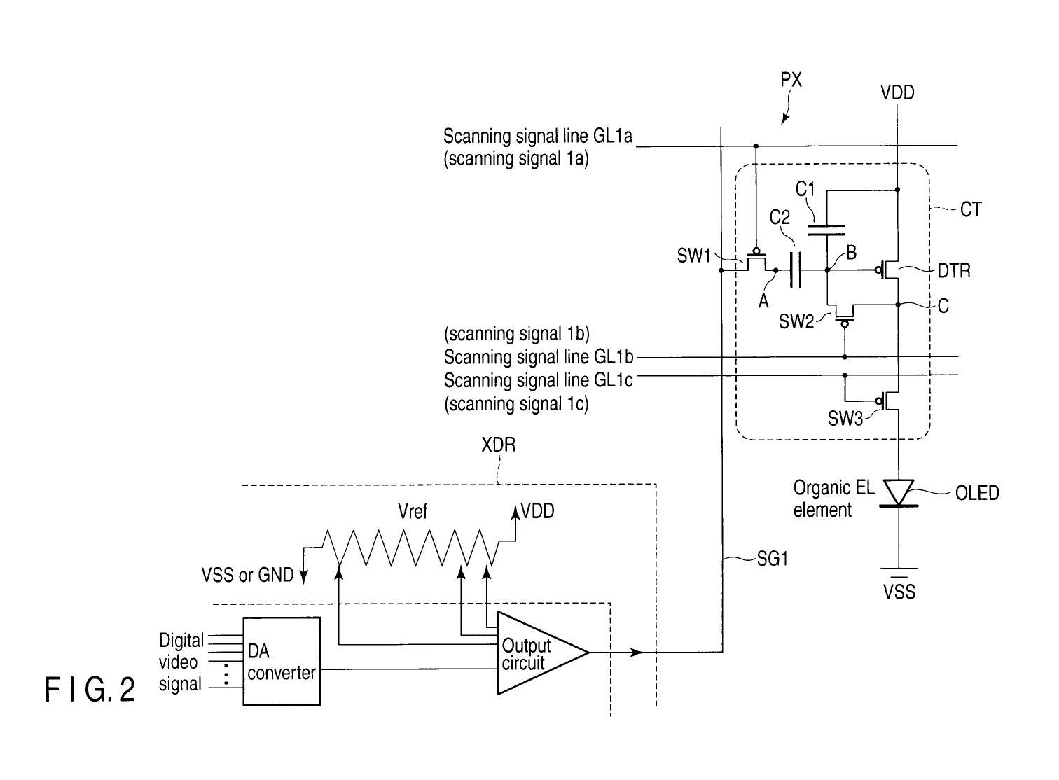

FIG. 2 is an exemplary view showing the configuration and the connection of the pixel PX and the video signal line driver XDR of the present embodiment.

The circuit configuration of the pixel PX will be described below. The circuit will be described for the pixel PX arranged in one row and one column of the matrix, but the configuration is similar for other pixels PX.

The pixel PX comprises an organic EL element OLED, and a pixel circuit CT that generates a light emission current corresponding to an image signal and supplies the same to the organic EL element OLED.

A drive current control element DTR is connected in series with the organic EL element OLED between a pair of power supply terminals VDD, VSS. The drive current control element DTR outputs a drive current having a magnitude corresponding to the voltage between the control terminal thereof and the power supply terminal VDD to the organic EL element OLED.

A selection switch SW1 is connected between the video signal line SG1 and the control terminal of the drive current control element DTR. In other words, the selection switch SW1 includes the source connected to the video signal line SG1a, the drain connected to the control terminal of the drive current control element DTR through a capacitor C2, to be described later, and the gate connected to the corresponding scanning signal line GL1a. The selection switch SW1 switches conduction/non-conduction between the video signal line SG1 and the terminal on the selection switch SW1 side of the capacitor C2 according to the scanning signal la provided through the scanning signal line GL1a.

The capacitor C1 is connected between the power supply terminal VDD and the control terminal of the drive current control element DTR. The capacitor C1 holds the voltage between the control terminal of the drive current control element DTR and the power supply terminal VDD at substantially constant for a predetermined period.

Specifically, when the video signal line SG1 and the control terminal of the drive current control element DTR are in the conductive state by the scanning signal 1a provided through the scanning signal line GL1a from the scanning signal line driver YDR in correspondence with the writing operation, the selection switch SW1 outputs the signal such as the video signal Vsig provided from the video signal line driver XDR through the video signal line SG1 to the node A. The drive current control element DTR supplies the drive current Id having the magnitude corresponding to the video signal Vsig output by the selection switch SW1 to the organic EL element OLED.

When the control terminal of the drive current control element DTR and the output terminal are in the conductive state by the scanning signal 1b provided through the scanning signal line GL1b from the scanning signal line driver YDR in correspondence with the characteristics correcting operation (to be described later), the selection switch SW1 outputs the reset signal Vrst provided from the video signal line driver XDR through the video signal line SG1 to the node A.

A correction switch SW2 is connected between the output terminal and the control terminal of the drive current control element DTR. The correction switch SW2 switches the conduction/non-conduction between the output terminal and the control terminal of the drive current control element DTR according to the scanning signal 1b provided through the scanning signal line GL1b.

The output control switch SW3 is connected in series between the output terminal of the drive current control element DTR and the organic EL element OLED. The output control switch SW3 switches the conduction/non-conduction between the output terminal of the drive current control element DTR and the organic EL element OLED according to the scanning signal 1c provided through the scanning signal line GL1c.

The organic EL element OLED has a structure in which an organic layer including a light emitting layer or a thin film containing luminescence organic compound of red, green, or blue is interposed between the cathode and the anode. The organic EL element OLED generates an exciton by injecting electrons and holes to the organic layer and re-bonding the same, and emits light through light emission that occurs at the time of deactivation of the exciton. The organic EL element OLED may have a structure in which three layers of a hole transport layer (HTL), a light emitting layer (EML), and an electron transport layer (ETL) are stacked as an organic thin film layer between the anode and the cathode. The hole transport layer may have a structure comprising a plurality of layers. Furthermore, a hole block layer (HBL) may be arranged in the organic thin film layer.

The configuration and the operation of the video signal line driver XDR will now be described.

In the video signal line driver XDR shown at the lower left in FIG. 2, a DA converter converts the digital video signal output from the controller 3 to an analog form, and an output circuit generates an output voltage corresponding to the gamma characteristics from the video signal with reference to the reference voltage Vref. The video signal Vsig obtained as a result is provided to the video signal line SG1. The output circuit generates the reset signal Vrst at the time of the characteristics correcting operation described above, and outputs the same to the video signal line SG1.

The operation of the circuit of the pixel PX in the two-dimensional display will now be described.

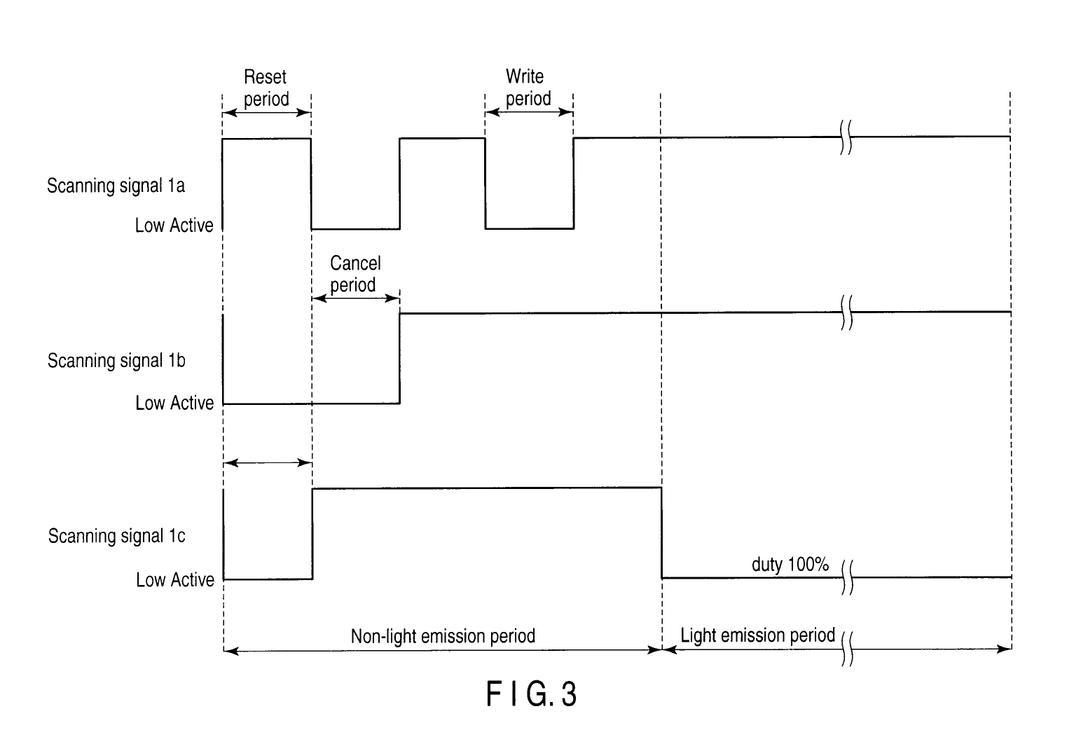

FIG. 3 is an exemplary timing chart showing the scanning signals 1a to 1c provided from the scanning signal lines GL1a to GL1c to the pixel PX according to the present embodiment. In the timing chart, the corresponding selection switch SW1, the correction switch SW2 and the output control switch SW3 are conducted when the scanning signals 1a to 1c become low level.

As shown in FIG. 3, the drive state of the pixel PX includes a light emission period in which the organic EL element OLED emits light, and a non-light emission period in which the organic EL element OLED does not emit light. The non-light emission period includes a reset period, a cancel period, a write period, and the like. The characteristics correcting operation is executed in the reset period and the cancel period, and the video signal is written to the pixel circuit in the write period.

In the reset period, the voltage between the input terminal and the control terminal of the drive current control element DTR is set to be greater than the threshold voltage Vth thereof. Specifically, the switches SW2 and SW3 are turned ON. According to such operation, the potential of the nodes B and C lowers by the discharging current flowing through the correction switch SW2.

In the following threshold cancel period, the output control switch SW3 is set to be turned OFF while the switches SW1, SW2 are turned ON. The potential of the node B thus rises to the level substantially equal to the threshold voltage Vth of the drive current control element DTR by the charging current flowing through the correction switch SW2. In this case, the reset signal Vrst is provided to the electrode on the node A side of the capacitor C2.

In the write period, the selection switch SW1 is turned ON and the switches SW2 and SW3 are turned OFF. The video signal Vsig is provided to the node A through the selection switch SW1 instead of the reset signal Vrst provided through the selection switch SW1. As a result, the potential of the node B becomes substantially equal to the sum of the threshold voltage Vth and the video signal Vsig.

In the light emission period, the output control switch SW3 is turned ON and the switches SW1, SW2 are turned OFF. The drive current Id is thus supplied to the organic EL element OLED through the output control switch SW3. The drive current Id is determined by the potential of the node B held by the capacitor C1, and even if the threshold voltage Vth of the drive current control element DTR varies among the pixels PX, the influence of such variation on the drive current Id can be excluded.

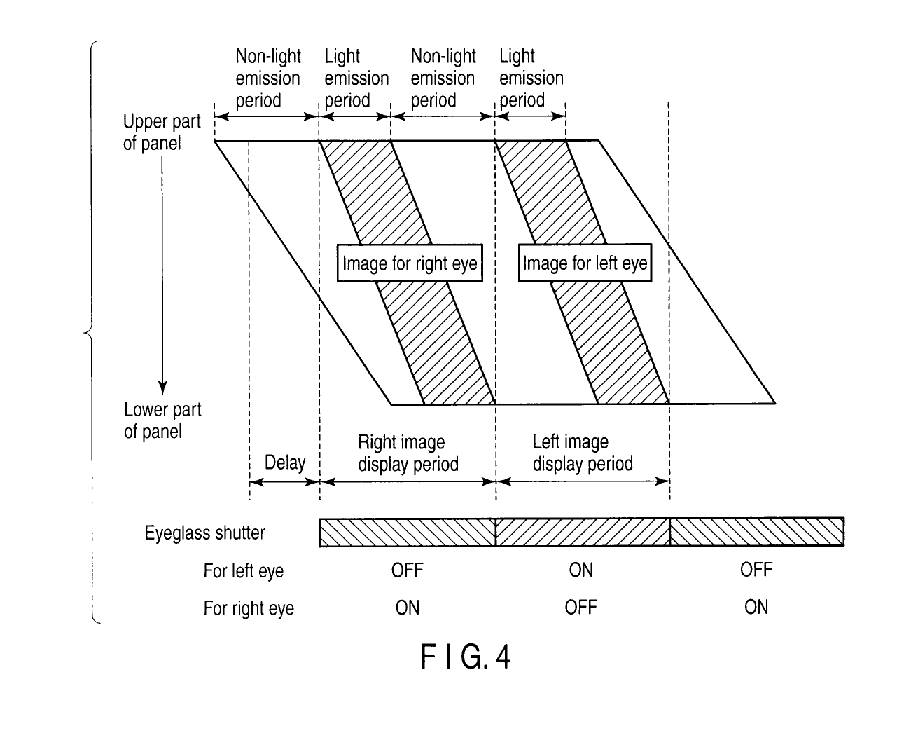

FIG. 4 is an exemplary view describing the three-dimensional display method in the organic EL display device of the present embodiment.

In FIG. 4, the image for the right eye is displayed with the odd number image and the image for the left eye is displayed with the even number image. The horizontal direction shows the flow of time, and the vertical direction shows the position in the height direction of the screen. The period of displaying the odd number image is configured by the non-display period (non-light emission period) and the display period (light emission period) of the image for the right eye, and the period of displaying the even number image is configured by the non-display period (non-light emission period) and the display period (light emission period) of the image for the left eye.

Assuming the upper end (described as upper end for convenience. Indicate the side to first start the write of the information when using the lower end or the left and right direction depending on the using direction of the panel) of the display screen as the first line, the image for the right eye is displayed by writing the video information while sequentially selecting the lines to the lower side. Normally, when displaying one image, the period transitions to the light emission period of displaying the organic EL element through the non-light emission period of performing reset, write, and the like of the image signal. The organic EL element continues to display the same image until the next non-light emission period starts.

In the display method shown in FIG. 4, after the write of the video signal is performed, a delay time is provided in the first line and the light emission operation is started after elapse of the delay time. The delay time corresponds to the time until the light emission of the last line of the image one before ends. This is to prevent the image for the left eye and the image for the right eye from coexisting. The delay time is shortened every time the line to write the video signal is sequentially selected, and the light emitting operation is started without delay at the timing similar to the conventional one in the last line. Therefore, the delay time differs depending on the line position of the screen. However, the length of the light emission period is the same in each line.

In the display method, the light emission period of the first line (line at very top) of the image for the left eye is started after the light emission period of the last line (line at the very bottom) of the image for the right eye ends. Therefore, the image for the right eye and the image for the left eye do not coexist at the same time.

The period in which the light emission continues is the longest when the timing at which the light emission period for displaying the image for the right eye ended and the timing at which the light emission for displaying the image for the left eye started coincide as shown in FIG. 4.

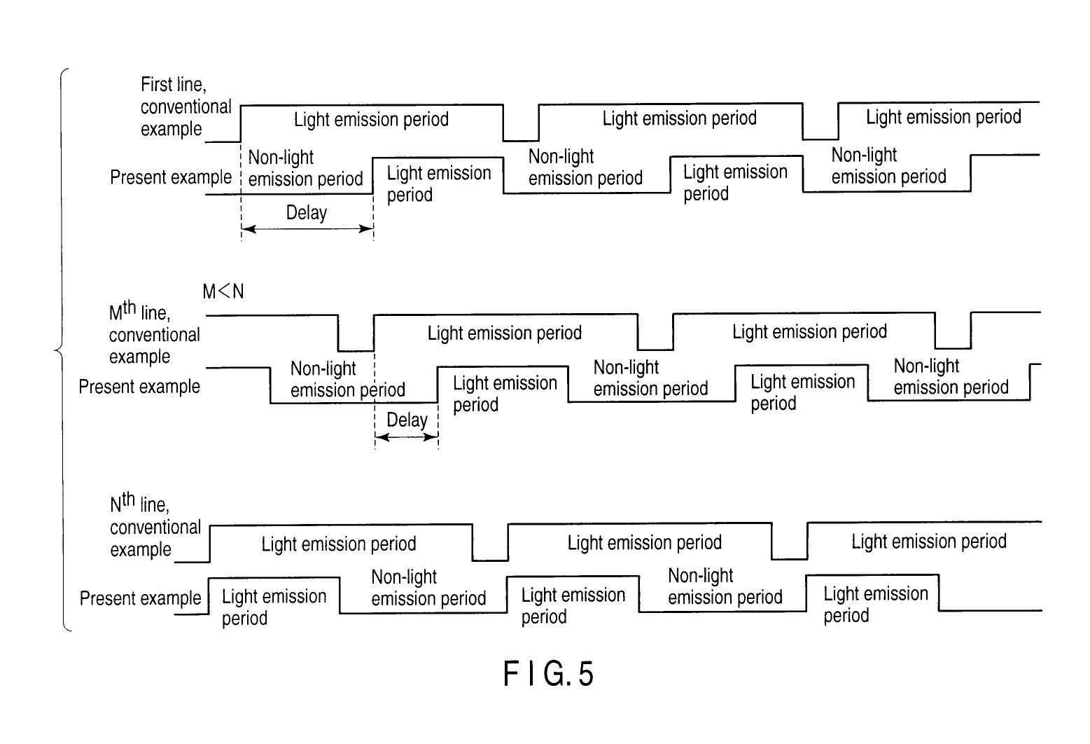

FIG. 5 is an exemplary timing chart showing the light emitting operation for every line of the present embodiment. FIG. 5 shows the conventional light emission period and the light emission period in the present embodiment for every line in comparison.

An example of the M^{th} line where M<N is shown in the middle level of FIG. 5. The M^{th} line is near substantially the center of the screen. Thus, the light emitting operation starts when the period of about ½ has elapsed from the start of the conventional light emission period through the delay time, and the non-light emission period starts after emitting light for a predetermined time.

An example of the N^{th} line or the last line is shown in the lower level of FIG. 5. The light emission period starts without delay since it is the last line, and the non-light emission period starts after emitting light for a predetermined time.

The following scanning signal drive is carried out to realize the operation shown in FIG. 5.

(1) The reset operation, the cancel operation, and the write operation are executed in the conventional timing and procedure.

(2) All the switches SW1, SW2, SW3 are turned OFF after the write operation.

(3) The scanning signal 1c is controlled to turn ON the output control SW3 at the time point a predetermined delay time has elapsed for every line. The light emitting operation is thus started.

(4) The scanning signal 1c is controlled to turn OFF the output control SW3 after a predetermined time has elapsed from the start of light emission.

Such scanning signal drive can be realized when the scanning signal line driver YDR operates as a drive unit based on the signal from the controller 3.

The configuration of the scanning signal line driver for realizing such scanning signal drive will now be described.

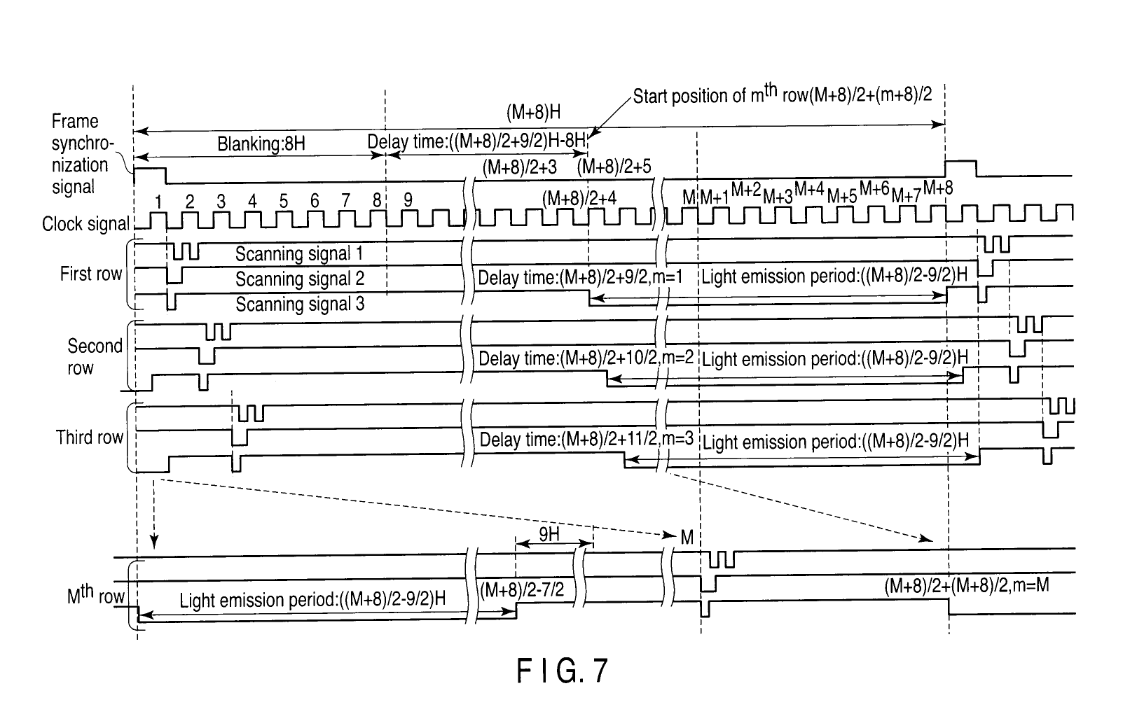

FIG. 7 is an exemplary timing chart showing the detailed signal for realizing the light emission timing shown in FIG. 5 of the present embodiment. The timing chart describes the frame synchronization signal, the clock signal, and the scanning signal for each row.

This drive method is an example of when the blanking period or the non-display period in which operations such as characteristics correction and video signal reading are performed is 8H (horizontal period), and the maximum number of rows of the organic EL device is M rows. In this case, one frame period is (M+8) H period.

The operation of one frame starts by the rise of the frame synchronization signal. First, the reset/cancel/write operation of the first row is carried out, and then the operation sequentially proceeds to the second row and then the third row. The details of the reset/cancel/write operation have already been described with reference to FIG. 3, and thus the redundant description will be omitted.

In the example, a 9H period is provided as a dummy period before moving on to the operation of the next frame. The light emission period is half of about one frame period. More specifically, half of the period excluding the dummy period from the frame period, that is, the light emission period is ((M+8)/2−9/2) H period. The delay period is the period until the light emission period starts after the elapse of the blanking period. Therefore, under the above described conditions, the light emission period is reached through a predetermined delay period after the blanking period in the first row, where the delay period is ((M+8)/2+9/2)H−8H period.

The operation start timing is normally delayed by 1H (horizontal period) by progression for one row, but the delay time until the start of light emission is reduced by 1/2H in the present embodiment. Therefore, when the operation progresses to the M^{th} row, the light emission period is reached with the delay of only 1H period after the blanking period. The light emission period can be appropriately set so that the light emission period of the first row and the light emission period of the M^{th} row do not overlap.

In the case of this example where the original blanking period is 8H, ((M+8)/2−3/2)H can be adopted as a maximum light emission period if reduced to the dummy period 3H without changing the entire frame period.

As apparent from the timing chart, in the present embodiment, the control is performed such that the time from the end of the write operation until the start of the light emitting operation becomes sequentially shorter from the first row to the last row of the pixel circuit.

Specifically, the write end timing of the scanning signal 1 of the first row is the fall timing of the second clock pulse, and the write end timing of the scanning signal 1 of the second row is the fall timing of the third clock pulse. Therefore, the timing of the signal of the scanning signal 1 is delayed by one pulse of the clock pulse by the progression of one row.

The light emission timing of the scanning signal 3 of the first row is the rise timing of the (M+8)/2+3^{rd} clock pulse, and the light emission timing of the scanning signal 3 of the second row is the fall timing of the (M+8)/2+3^{rd} clock pulse. Therefore, the timing of the signal of the scanning signal 3 is delayed by the time corresponding to ½ pulse by the progression of one row.

As a result, the period from the write end timing to the light emission start timing becomes shorter by the time corresponding to ½ pulse by the progression of one row.

The clock signal is configured by a pulse train that becomes a reference in generating the scanning signal. The clock signal may be input as a synchronization signal from the controller 3, or may be generated by a clock generation circuit (not illustrated) in the scanning signal line driver YDR.

The configuration of the scanning signal line driver YDR that generates the scanning signals 1 to 3 that controls the light emission period shown in the timing chart described above will now be described.

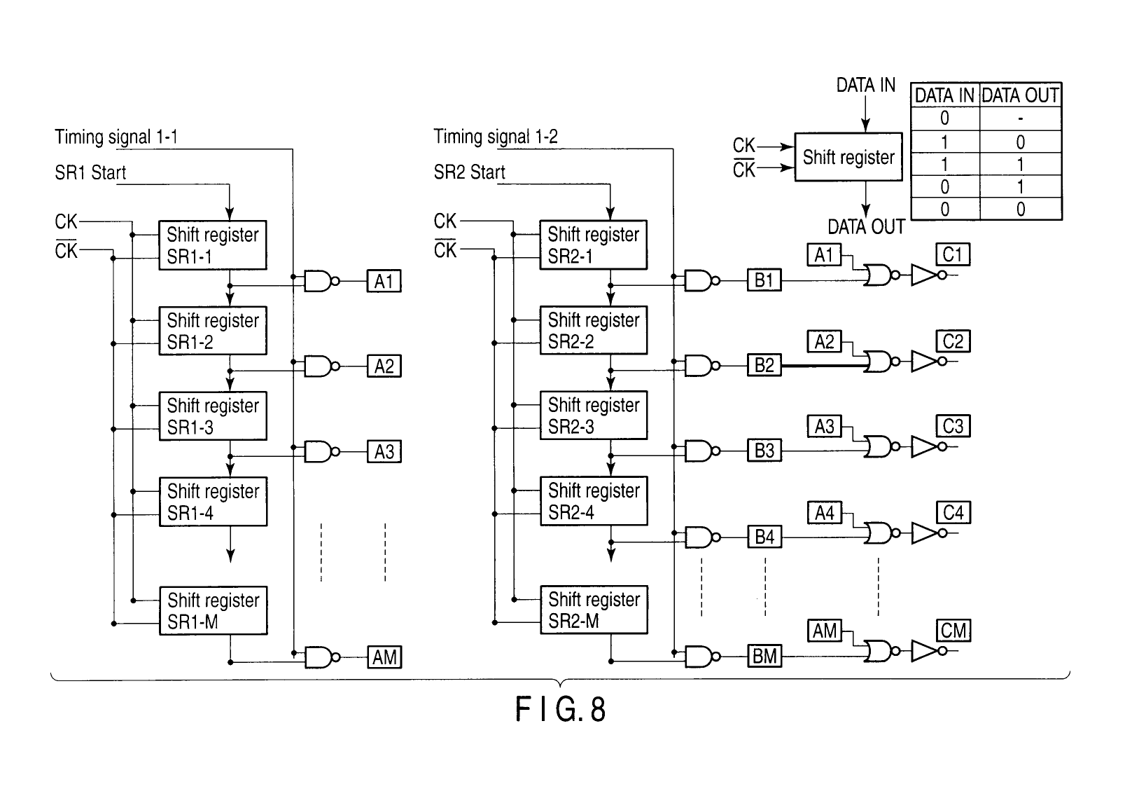

FIG. 8 is an exemplary view showing one example of a circuit configuration for generating the scanning signal 1 of the present embodiment. A series of shift registers combining a basic shift register for inputting a clock CK and an inverted signal of the clock and sequentially holding and outputting the data input is combined for two columns and synthesized with the NOR circuit to obtain the scanning signal 1.

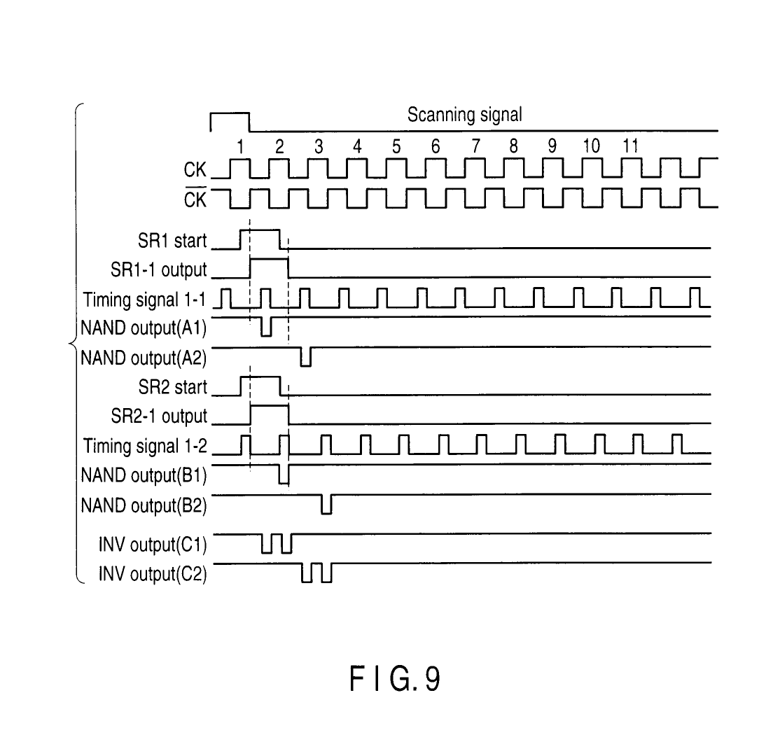

FIG. 9 is an exemplary timing chart showing the detailed signal for realizing the scanning signal 1 of the present embodiment. In the timing chart, the timing signal, the SR (shift register) start signal, and the clock signal CK are signals provided from the controller 3.

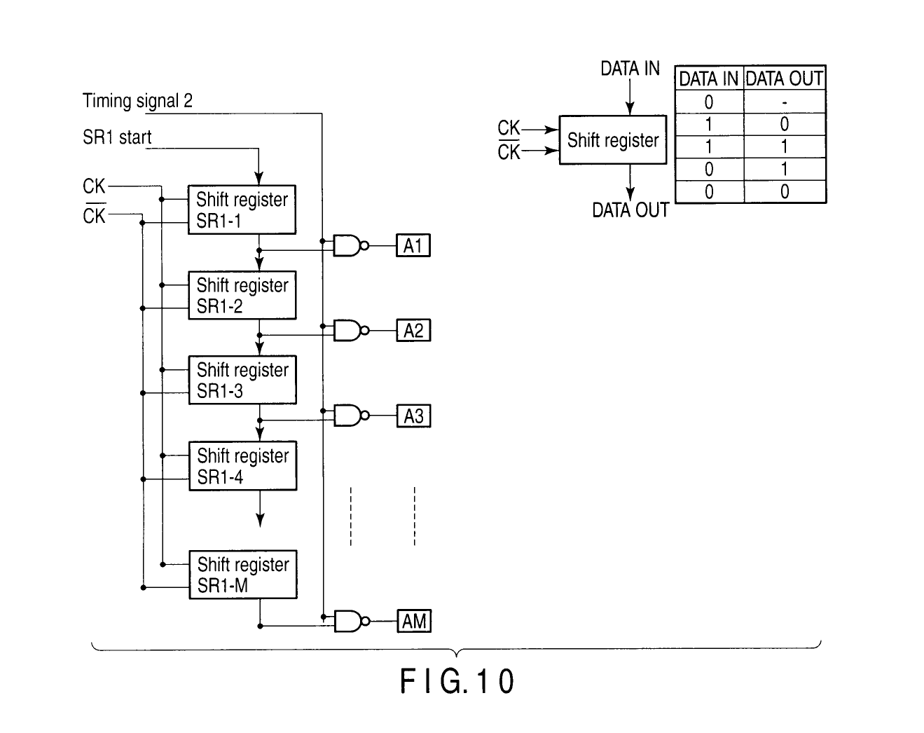

FIG. 10 is an exemplary view showing one example of a circuit configuration for generating the scanning signal 2 of the present embodiment. Similar to FIG. 8, the configuration by the shift register column is adopted.

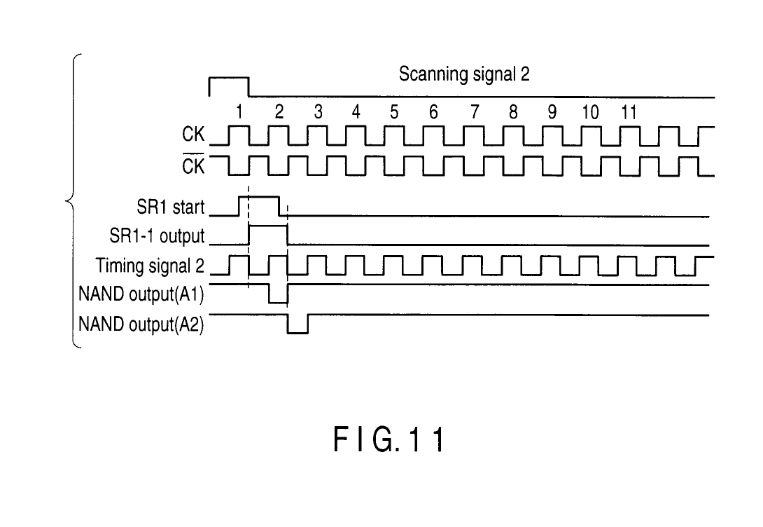

FIG. 11 is an exemplary timing chart showing the detailed signal for realizing the scanning signal 2 of the present embodiment. In the timing chart, the timing signal, the SR (shift register) start signal, and the clock signal CK are signals provided from the controller 3.

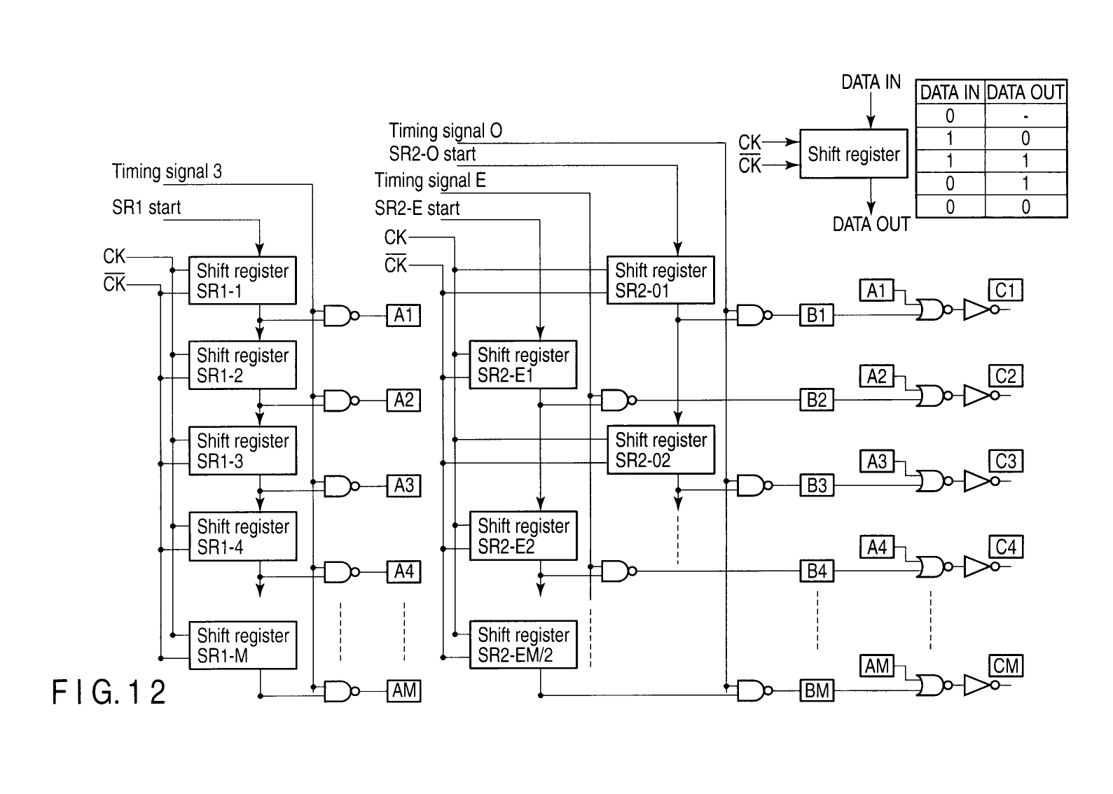

FIG. 12 is an exemplary view showing one example of a circuit configuration for generating the scanning signal 3 of the present embodiment. The signal for controlling so that the delay amount differs for every row is generated in the output of the two series of shift register circuits on the right side of the figure. The two series of shift register circuits are circuits for the odd number row and for the even number row. In the configuration of the odd number side shift register circuit, the shift register output of the first row is the shift register input of the third row, and the output signal of the odd number row is sequentially generated. In the configuration of the even number side shift register circuit, the shift register output of the second row is the shift register input of the fourth row, and the output signal of the even number row is sequentially generated.

In FIG. 12, a case in which M is an even number is shown, where the M^{th} row is connected to the odd number column in the case of the odd number. The even number side operates at a timing shifted by half a clock with respect to the odd number side, where the clock and the inversion of the clock are reversely connected.

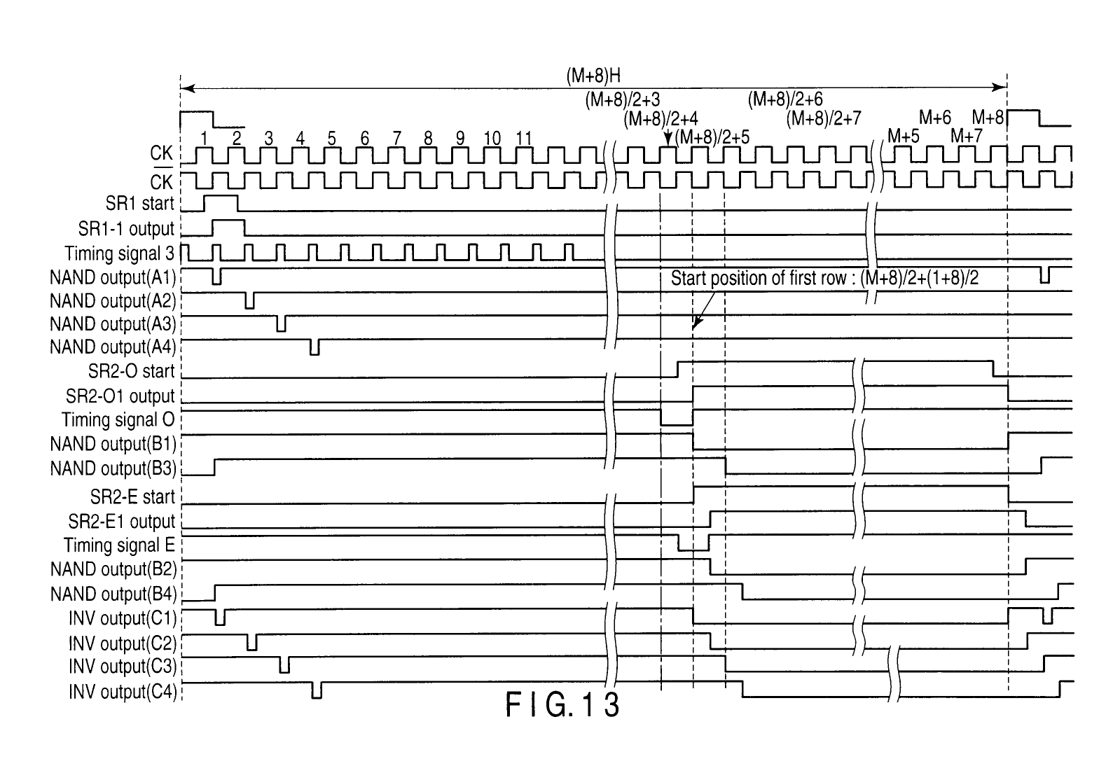

FIG. 13 is an exemplary timing chart showing the detailed signal for realizing the scanning signal 3 of the present embodiment. In the timing chart, the timing signal, the SR (shift register) start signal, and the clock signal CK are signals provided from the controller 3.

The second row normally has a shift amount worth 1H with respect to the first row, but the shift normally corresponding to the shift worth 1H becomes a shift worth 1/2H by operating the two shift register columns shifted by half a clock, whereby the 1/2H light emission timing shifts forward and the delay period is shortened.

Similarly, the third row has a shift worth 2H (horizontal period) with respect to the first row in the normal circuit, but the shift worth 1H occurs in the case of the relevant circuit configuration, and hence the light emission timing shifts forward by one horizontal period and the delay period is shortened.

The shift (shortening of the delay time) becomes greater with more number of rows, where an example in which the light emission period is reached after the blanking period+1H in the final row is shown in the present figure. The light emission period can be changed from the present example as described above.

According to the display method of the embodiment described above, a state in which the left and right images are simultaneously displayed does not occur. The operation of the eyeglass shutter is also shown at the lower part of FIG. 4. Since the shutter can be opened and closed in accordance with the left and right image display period corresponding to the light emission timing, the left and right parallax can be accurately recognized and an image holding the three-dimensional quality can be provided as expected in the original three-dimensional method.

However, it is also effective to set so that the luminance becomes greater than the luminance in the normal light emission period since the light emission period becomes shorter.

A method of setting the gamma in advance, a method of increasing the write voltage (current), and the like are known for the modulation of the luminance. The method by time modulation can also be combined. The luminance modulation unit for executing the luminance modulation can be incorporated in the controller 3.

Furthermore, in the display method of the present embodiment, the lowering from a predetermined luminance may occur depending on the leakage amount of the capacitor C1 since the holding period from the write of the video signal to the start of light emission differs depending on the screen position. In such a case, the luminance may be adjusted according to the display position.

The pixel PX described above is a type (voltage program method) of writing the video voltage, but may be a type (current program) of writing the video current.

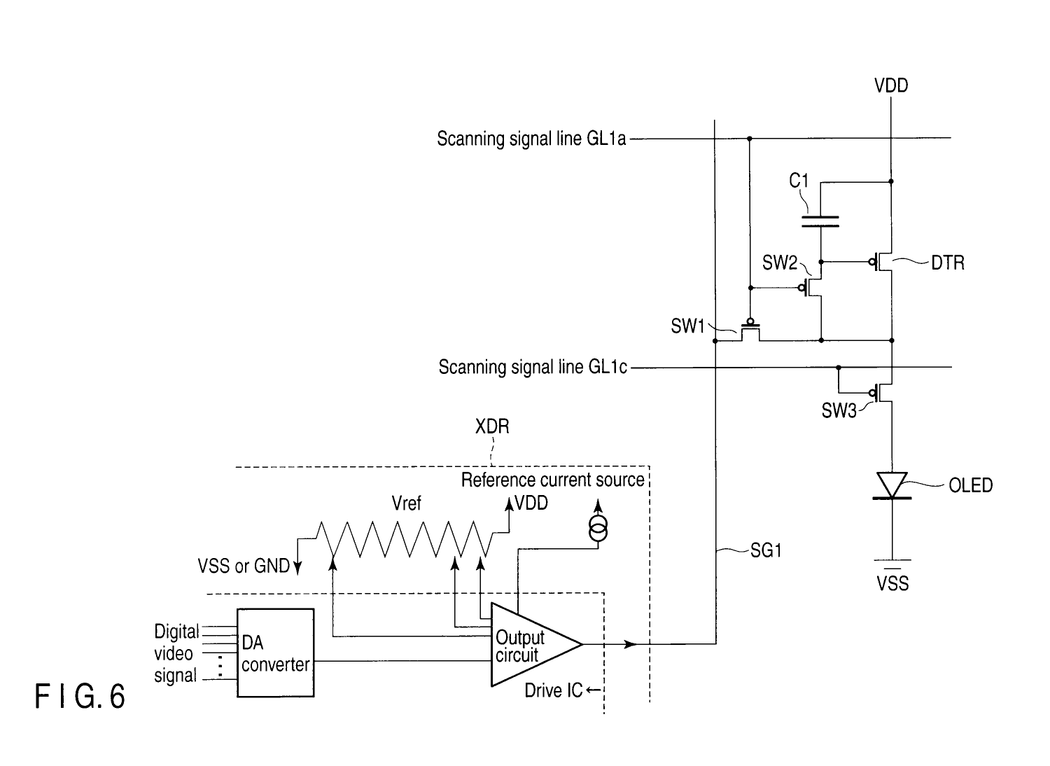

FIG. 6 is an exemplary view showing the configuration and the connection of the pixel PX of the current program method and the video signal lien driver XDR of the present embodiment. When using the pixel PX of such type, two operation signal lines may be provided with respect to one pixel PX. The video signal line driver XDR may convert the digital video signal to current using the internally arranged reference current source for output.

In the image data write method by current as well, the adjustment operation of the light emission period by the scanning signal through the scanning signal line is the same in principle as the voltage program method described above. Therefore, the detailed description on the operation of the pixel circuit will be omitted.

As shown in FIG. 1, in the present embodiment, the scanning signal line driver YDR and the video signal line driver XDR are arranged on the organic EL panel, and the controller is arranged on the external printed board, but not limited to such mode, they may be arranged on either the organic EL panel or the printed board. For instance, the scanning signal line driver YDR and the video signal line driver XDR may not be arranged on the organic EL panel, but the scanning signal and the video signal may be received therefrom through the signal line.

The pixel circuit shown in the above-described embodiment is an example and may be configured in various variations without being limited to the relevant mode.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An organic EL display device comprising:
a plurality of pixels configured to be arranged in a matrix form and include an organic EL element and a pixel circuit which controls light emission/non-light emission of the organic EL element;
a plurality of video signal lines configured to be connected to the pixel circuit for every column and provides a video signal; and
a plurality of scanning signal lines configured to be connected to the pixel circuit for every row and provide a write control signal for controlling a video write operation of the pixel circuit, and configured to be connected to the organic EL element for every row and provide a light emission control signal for controlling a light emitting operation of the organic EL element,
the write control signal and the light emission control signal being generated based on a clock pulse train, which is a reference signal, and
a waiting time from a video write end timing to the pixel circuit to a light emission start timing of the organic EL element in an arbitrary row being different from the waiting time in an adjacent row by a time corresponding to ½ clock pulse.

2. The organic EL display device according to claim 1, wherein the waiting time from the video write end timing to the pixel circuit to the light emission start timing of the organic EL element in an M^{th} row differs from the waiting time in an N^{th} (N>M) row by a time corresponding to (N−M)/2 clock pulse.

3. The organic EL display device according to claim 1, wherein the video signal line provides an image for left eye and an image for right eye for a stereoscopic display alternately for every frame as video signals.

4. The organic EL display device according to claim 3, further comprising a shutter signal output circuit which outputs a synchronization signal for opening and closing a shutter of a stereoscopic eyeglass in synchronization with the respective periods of displaying the image for right eye and the image for left eye.

5. The organic EL display device according to claim 1, wherein a light emission period for one frame and a light emission period for a following frame are separated.

6. The organic EL display device according to claim 1, further comprising:
a video signal line driver configured to generate a video signal and provide the signal to the plurality of video signal lines; and
a scanning signal line driver configured to generate the write control signal and the light emission control signal, and provide the signals to the scanning signal lines.

7. The organic EL display device according to claim 1, wherein the scanning signal line driver outputs a signal to the scanning signal line to write the video signal from the pixel circuit at the upper column toward the pixel circuit at the lower column of the organic EL display device.

8. An organic EL display method of an organic EL display device, the organic EL display device including a plurality of organic EL elements arranged in a matrix form, a pixel circuit which is arranged with respect to each organic EL element and controls light emission/non-light emission of the organic EL element, a plurality of video signal lines which is connected to the pixel circuit for every column and provides a video signal, and a plurality of scanning signal lines connected to the pixel circuit for every row, each of which supplies a write control signal for controlling an operation of writing the video signal to the pixel circuit and a light emission control signal for controlling a light emitting operation of the organic EL element, the method comprising:
transmitting a first write control signal to the pixel circuit arranged in M rows (M is an integer);
writing a first video signal to the pixel circuit corresponding to the organic EL element arranged in the M row in synchronization with a first clock pulse signal;
causing the organic EL element arranged in the M row to emit light based on a first light emission control signal after elapse of a time corresponding to a predetermined number of clock pulses after the write of the first video signal is finished;
transmitting a second write control signal to the pixel circuit arranged in N rows (N is an integer greater than M);
writing a second video signal to the pixel circuit corresponding to the organic EL element arranged in the N row in synchronization with a second clock pulse signal subsequent to the first clock pulse signal; and
causing the organic EL element arranged in the N row to emit light based on a second light emission control signal after elapse of a time shorter than the time corresponding to the predetermined number of clock pulses after the write of the second video signal is finished.

9. The organic EL display method according to claim 8, wherein a waiting time from a video write end timing to the pixel circuit to a light emission start timing of the organic EL element in an M^{th} row differs from the waiting time in an N^{th} (N>M) row by a time corresponding to (N−M)/2 clock pulse.

10. The organic EL display method according to claim 8, wherein an image for left eye and an image for right eye for stereoscopic display are provided to the video signal line alternately for every frame as video signals.

11. The organic EL display method according to claim 10, wherein a synchronization signal for opening and closing a shutter of a stereoscopic eyeglass is output in synchronization with the respective periods of displaying the image for right eye and the image for left eye.

12. The organic EL display method according to claim 8, wherein a light emission period for one frame and a light emission period for a following frame are separated.

13. The organic EL display method according to claim 8, wherein a signal is output to the scanning signal line to write the video signal from the pixel circuit at the upper column toward the pixel circuit at the lower column of the organic EL display device.

14. An organic EL display device comprising:
a plurality of pixels configured to be arranged in a matrix form and include an organic EL element and a pixel circuit which controls light emission/non-light emission of the organic EL element;
a plurality of video signal lines configured to be connected to the pixel circuit for every column and provide a video signal; and
a plurality of scanning signal lines configured to be connected to the pixel circuit for every row for causing a write operation of writing the video signal provided through the video signal line to the pixel circuit in a write period and a light emitting operation of the organic EL element to be sequentially executed for every row of the pixel circuit, and provide a scanning signal for controlling in a manner that a time from end of the write operation to start of the light emitting operation sequentially becomes shorter from a first row to a last row of the pixel circuit while keeping a light emission duration in each organic EL element constant.

15. The organic EL display device according to claim 14, wherein the scanning signal line executes the write operation of the video signal and the light emitting operation of the organic EL element with respect to the pixels of the last row, and then returns to the pixels of the first row to sequentially execute the respective operations, and provides a scanning signal for controlling a timing to start the light emitting operation for the pixels of the first row after the light emitting operation for the pixels of the last row is finished.

16. The organic EL display device according to claim 15, wherein the scanning signal line provides a scanning signal for controlling the timing to start the light emitting operation for the pixels of the first row to substantially the same as the timing at which the light emitting operation is finished for the pixels of the last row.

17. The organic EL display device according to claim 14, wherein the video signal line provides an image for left eye and an image for right eye for stereoscopic display alternately for every frame as video signals.

18. The organic EL display device according to claim 14, further comprising:
a video signal line driver configured to generate a video signal and provide the signal to the plurality of video signal lines; and
a scanning signal line driver configured to generate the write control signal and the light emission control signal, and provide the signals to the scanning signal lines.

19. An organic EL display method of an organic EL display device, the organic EL display device including a plurality of pixels arranged in a matrix form and including an organic EL element and a pixel circuit that controls light emission/non-light emission of the organic EL element; a plurality of video signal lines configured to be connected to the pixel circuit for every column and provide a video signal; and a plurality of scanning signal lines configured to be connected to the pixel circuit for every row and provide a scanning signal for controlling a video write operation of the pixel and a light emitting operation of the organic EL element, the method comprising:
controlling the scanning signal to be provided to the video signal line connected to a first row of the pixel to cause the organic EL element to emit light after delayed by a predetermined time from the end of the write operation of the video signal;
controlling each scanning signal to be provided to the respective video signal line connected from the second row to the last row of the pixel to sequentially execute the write operation of the video signal and the light emitting operation of the organic EL element for every row of the pixel, and to control in a manner that a time from the end of the write operation to the start of the light emitting operation sequentially becomes shorter from the first row to the last row of the pixel while keeping a light emission duration in each pixel constant; and
controlling to repeatedly execute the supply of the series of scanning signals from the first row sequentially to the last row of the pixel after controlling the scanning signal to be provided to the video signal line connected to the last line.

20. The organic EL display method according to claim 19, wherein a signal is output to the scanning signal line to write the video signal from the pixel at the upper column toward the pixel at the lower column of the organic EL display device.
